(19) United States
(12) Patent Application Publication
(10) Pub. No.: US 2026/0141742 A1
(43) Pub. Date: May 21, 2026

(54) IMAGE PROCESSING METHOD AND SYSTEM CONTAINING TEXT, AND STORAGE MEDIUM

(71) Applicant: Hangzhou Ruisheng Software Co., Ltd., Zhejiang (CN)

(72) Inventors: Qingsong Xu, Zhejiang (CN); Qing Li, Zhejiang (CN)

(73) Assignee: Hangzhou Ruisheng Software Co., Ltd., Zhejiang (CN)

(21) Appl. No.: 19/119,759

(22) PCT Filed: Sep. 12, 2023
(86) PCT No.: PCT/CN2023/118268

§ 371 Date: Apr. 9, 2025

(30) Foreign Application Priority Data
Oct. 10, 2022 (CN) 202211236549.1

(51) Int. Cl. G06V 30/18; G06V 20/70

(52) U.S. Cl. CPC G06V 30/18067; G06V 20/70

(57) ABSTRACT

An image processing method and system containing text, and a storage medium, the method including: obtaining an original image; processing the original image to obtain a preprocessed image, wherein the preprocessed image includes at least one text mask area; obtaining an outer contour of the at least one text mask area to obtain at least two contour curves; fitting the contour curves of the outer contour to obtain a curve function thereof; straightening the contour curves via the curve function to obtain an intermediate image, wherein the intermediate image includes at least two second lines, and the at least two second lines correspond to the at least two contour curves one by one; remapping the original image based on a mapping relationship between the preprocessed image and the intermediate image to obtain an output image.

### FIELD OF THE INVENTION

The invention relates to the field of computer techniques, and in particular to an image processing method and system containing text, and a storage medium.

### DESCRIPTION OF RELATED ART

With the development of digital techniques, documents may be scanned or photographed to be converted into electronic images, and the electronic images may be readily stored and transmitted over the Internet. Furthermore, the document image may be recognized using an image recognition technique or the like to obtain information recorded in the document image. However, in the process of scanning or photographing a document to obtain an electronic image, it is inevitable that the content in the obtained electronic image may be tilted, distorted, or deformed. Such tilt, distortion, or deformation has an adverse effect on processing such as analysis of the electronic image, for example, making the recognition results inaccurate, etc., and also affecting the browsing experience of the user.

### SUMMARY OF THE INVENTION

One of the objects of the disclosure is to provide an image processing method containing text, including:
obtaining an original image;
processing the original image to obtain a preprocessed image, wherein the preprocessed image includes at least one text mask area;
obtaining an outer contour of the at least one text mask area to obtain at least two contour curves;
fitting the contour curves of the outer contour to obtain a curve function thereof;
straightening the contour curves via the curve function to obtain an intermediate image, wherein the intermediate image includes at least two second lines, and the at least two second lines correspond to the at least two contour curves one by one;
remapping the original image based on a mapping relationship between the preprocessed image and the intermediate image to obtain an output image.

In some embodiments, the mapping relationship between the preprocessed image and the intermediate image includes: a mapping relationship between the at least two contour curves and the at least two second lines, and a mapping relationship between an area between the at least two contour curves in the preprocessed image and an area between the at least two second lines in the intermediate image.

In some embodiments, remapping the original image based on the mapping relationship between the preprocessed image and the intermediate image to obtain the output image includes:
determining preprocessing mapping information corresponding to the preprocessed image via an interpolation method based on the mapping relationship between the preprocessed image and the intermediate image, wherein the preprocessing mapping information is used to indicate a mapping parameter of at least a portion of pixels in the preprocessed image;
determining mapping information corresponding to an area in the preprocessed image corresponding to the original image based on the preprocessing mapping information;
remapping the original image based on the mapping information corresponding to the original image to obtain the output image.

In some embodiments, processing the original image to obtain the preprocessed image includes: annotating a text in the original image based on a pre-trained annotation model to obtain the at least one text mask area.

In some embodiments, a training process of the annotation model includes:
obtaining a sample image, wherein the sample image includes at least one text line area, and the at least one text line area is arranged along a straight line;
performing a mask covering and annotating processing on the at least one text line area and distorting a processed sample image according to a random distortion value to obtain a distorted text mask area, thereby generating a target image;
distorting the sample image based on a same distortion value to obtain a distorted text line area, thereby generating a training image, wherein the distorted text mask area corresponds to the distorted text line area one by one;
training an annotation model to be trained based on the training image and the target image to obtain a trained annotation model.

In some embodiments, when the sample image includes a plurality of text line areas, the plurality of text line areas are arranged in parallel in sequence along a same direction.

In some embodiments, obtaining the outer contour of the at least one text mask area to obtain the at least two contour curves includes: obtaining the outer contour of the at least one text mask area using an OpenCV algorithm to obtain the at least two contour curves.

In some embodiments, obtaining the outer contour of the at least one text mask area to obtain the at least two contour curves further includes: removing contour curves for which lengths are less than a set threshold.

In some embodiments, after fitting the contour curves of the outer contour and obtaining the curve function thereof, the method further includes: extending the at least two contour curves according to the curve function.

According to another aspect of the disclosure, an image processing system containing text is proposed, including a processor and a memory, wherein a program is stored in the memory, and when the program is executed by the processor, the image processing system containing text above is implemented.

According to another aspect of the disclosure, a storage medium is provided, in which a program is stored, and when the program is executed, the image processing method containing text above is implemented.

Other features and advantages of the disclosure become more apparent from the following detailed description of exemplary embodiments of the disclosure with reference to the accompanying drawings.

### BRIEF DESCRIPTION OF THE DRAWINGS

The accompanying drawings, which constitute a portion of the specification, illustrate embodiments of the disclosure and, together with the specification, serve to explain the principles of the disclosure.

The disclosure may be more clearly understood from the following detailed description with reference to the accompanying drawings, wherein:

FIG. 1 shows a schematic flowchart of an image processing method containing text provided by an embodiment of the invention.

FIG. 2 shows a schematic diagram of a target image of a training annotation model provided by an embodiment of the invention.

FIG. 3 shows a schematic diagram of a training image of a training annotation model provided by an embodiment of the invention.

FIG. 4 shows a schematic diagram of an original image provided by an embodiment of the invention.

FIG. 5 shows a schematic diagram of a preprocessed image provided by an embodiment of the invention.

FIG. 6 shows a schematic diagram of obtaining the outer contour of a text mask area provided by an embodiment of the invention.

FIG. 7 shows a schematic diagram of a contour curve after extension processing provided by an embodiment of the invention.

FIG. 8 shows a schematic diagram of an intermediate image obtained after straightening a contour curve provided by an embodiment of the invention.

FIG. 9 shows a schematic diagram of an output image obtained by remapping provided by an embodiment of the invention.

FIG. 10 shows a schematic diagram of the structure of an image processing system containing text provided by an embodiment of the invention.

Note that in the embodiments described below, the same reference numerals may be used in common among different drawings to indicate the same portions or portions having the same functions, and the repeated descriptions thereof may be omitted. In some cases, similar reference numerals and letters are used to denote similar items, and thus, once an item is defined in one figure, further discussion thereof is not needed in subsequent figures.

For ease of understanding, the position, size, range, etc. of each structure shown in the drawings and the like may not represent the actual position, size, range, etc. Therefore, the disclosure is not limited to the position, size, range, etc. disclosed in the drawings and the like.

### DESCRIPTION OF THE EMBODIMENTS

Various exemplary embodiments of the disclosure are described in detail below with reference to the accompanying drawings. It should be noted that the relative arrangement of components and steps, the numerical expressions, and numerical values set forth in the embodiments do not limit the scope of the disclosure unless specifically stated otherwise.

The following description of at least one exemplary embodiment is merely illustrative in nature and is in no way intended to limit the disclosure and the application or uses thereof. That is, the structures and the methods herein are shown in an exemplary manner to illustrate different embodiments of the structures and methods in the disclosure. However, those skilled in the art may appreciate that they are merely illustrative of exemplary ways in which the disclosure may be implemented, and not exhaustive. Furthermore, the figures are not necessarily to scale, as some features may be exaggerated to show details of particular components.

Techniques, methods, and equipment known to those skilled in the art may not be discussed in detail, but where appropriate, such techniques, methods, and equipment should be considered a portion of the authorization specification.

In all examples shown and discussed herein, any specific values should be interpreted as merely exemplary and not as limiting. Therefore, other examples of the exemplary embodiments may have different values.

Currently, neural network models may be used to identify an electronic image to obtain the information recited in an electronic image. The electronic image may be an image taken or scanned by a user. In the process of obtaining the electronic image, due to reasons such as the shooting angle, it is unavoidable that the content in the electronic image is distorted or deformed, so that the results obtained by the neural network model recognition are inaccurate.

In the image processing method containing text provided in an embodiment of the disclosure, the original image is first annotated using an annotation model, and then a curve function is obtained according to the contour curves of the annotated text mask area, the contour curves are straightened according to the curve function, and then the original image is remapped according to a mapping relationship between a preprocessed image and an intermediate image to obtain an output image, thereby correcting the original image, effectively solving the issue of image distortion, improving the accuracy of recognition results obtained based on the output image, improving the efficiency of image recognition, enhancing the readability of the image, and improving the experience of the user of viewing the output image.

An image processing method containing text provided by an embodiment of the disclosure may be applied to an image processing system and a storage medium provided by an embodiment of the disclosure, and the image processing system and the storage medium may be disposed on an electronic equipment. The electronic equipment may be a personal computer, a mobile terminal, etc., and the mobile terminal may be hardware equipment having various operating systems such as a mobile phone, a tablet computer, etc. That is, the execution subject of the image processing method containing text may be a personal computer, a mobile terminal, etc.

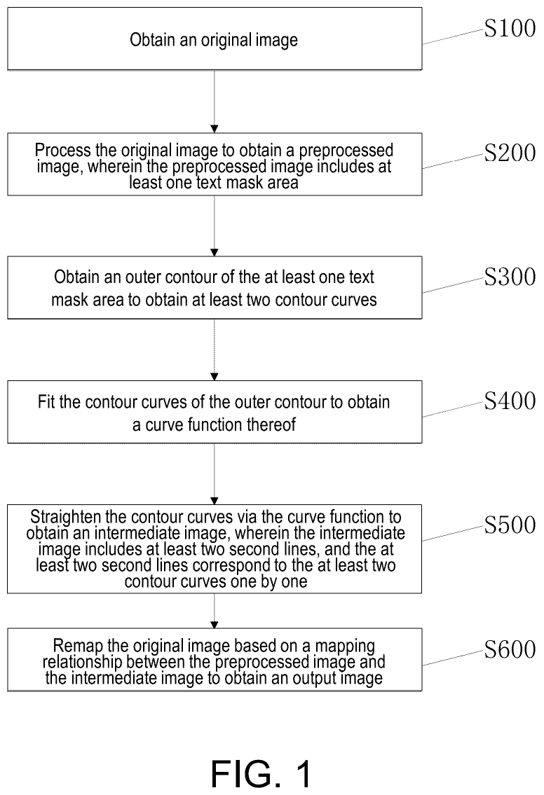

FIG. 1 shows a schematic flowchart of an image processing method containing text provided by an embodiment of the invention. As shown in FIG. 1, the invention provides an image processing method containing text, including:
step S100: obtaining an original image;
step S200: processing the original image to obtain a preprocessed image, wherein the preprocessed image includes at least one text mask area;
step S300: obtaining an outer contour of the at least one text mask area to obtain at least two contour curves;
step S400: fitting the contour curves of the outer contour to obtain a curve function thereof;
step S500: straightening the contour curves via the curve function to obtain an intermediate image, wherein the intermediate image includes at least two second lines, and the at least two second lines correspond to the at least two contour curves one by one;
step S600: remapping the original image based on a mapping relationship between the preprocessed image and the intermediate image to obtain an output image.

First, in step S100, an original image is obtained. An original image is an image obtained by photographing or scanning an object, which may be uploaded by a user or directly photographed. The object includes at least one of various characters, various symbols, and various graphics. The characters may include Chinese (for example, Chinese characters or pinyin), English, Japanese, French, Korean, Latin, numbers, etc., and the symbols may include mathematical symbols and punctuation marks, etc. Mathematical symbols include plus signs, minus signs, greater than signs, less than signs, percent signs, etc. Punctuation marks may include periods, commas, greetings, etc. Graphics may include straight lines, curves, circles, rectangles, heart shapes, various pictures, etc. The original image may include Chinese characters, English characters, numbers, graphics of buildings, graphics of people, etc.

The original image may be various types of images, and the objects may be, for example, business cards, test papers, exercise books, contracts, invoices, etc., so the original image may be an image of a shopping list, an image of a restaurant receipt, an image of a test paper, an image of an exercise book, an image of a contract, etc. For example, characters, symbols, and graphics, etc. may be obtained by handwriting, printing, or machine.

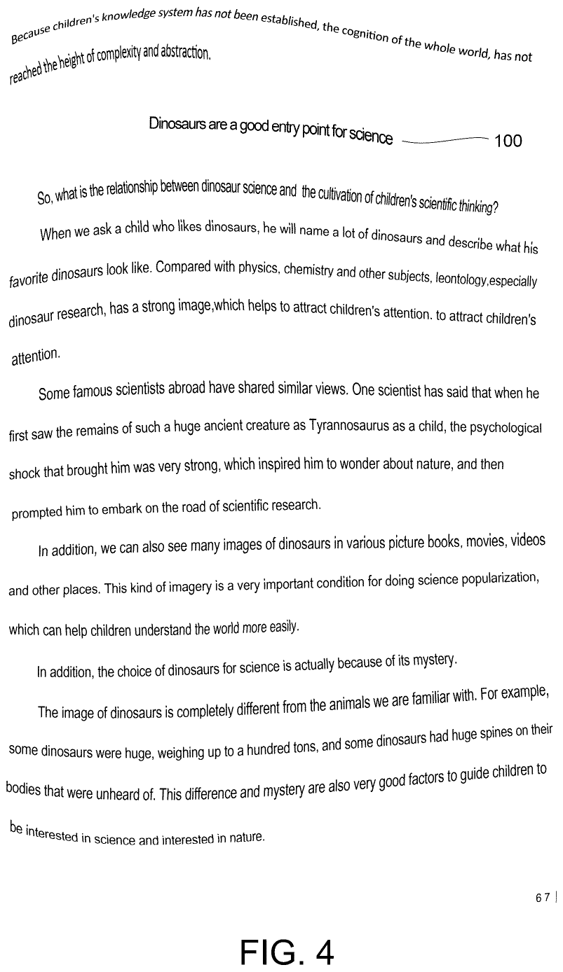

In some embodiments, the image content in the original image is distorted, that is, the objects in the original image are deformed, and the objects in the original image are inconsistent with the actual shapes thereof. For example, characters in the same row of the objects are tilted, twisted, distorted, etc. For example, the distortion may include one or a plurality of translation, rotation, scaling, affine transformation, perspective transformation, cylindrical transformation, and the like. For example, as shown in FIG. 4, in some embodiments, the original image may be an image obtained by photographing a page of a book, and the text in the original image is distorted. For example, in this page, the line connecting the centers of each text line should actually be on the same straight line. However, in the original image, the text lines are distorted, and the line connecting the centers of each text line is not on the same straight line, but on a curve (an irregular or regular curve).

The shape of the original image may be any suitable shape such as a rectangle. The shape and the size, etc. of the original image may be set by the user according to actual conditions, and the embodiments of the disclosure are not limited thereto.

The original image may be an image captured by an image acquisition device (e.g., a digital camera or a camera on a mobile phone, etc.), and the original image may be a grayscale image, a black-and-white image, or a color image. It should be noted that the original image refers to a form of presenting an object in a visual manner, such as a picture of the object. For another example, the original image may also be obtained by a method such as scanning. For example, the original image may be an image directly captured by the image acquisition device, or may be an image obtained after preprocessing the captured image. For example, in order to avoid the impact of data quality, data imbalance, etc. of the image directly captured by the image acquisition device on subsequent processing, the image processing method may also include an operation of preprocessing the image directly captured by the image acquisition device before processing the original image. The preprocessing may include, for example, performing processing such as cropping, gamma correction, or noise reduction filtering on the image directly captured by the image acquisition device. Preprocessing may eliminate irrelevant information or noise information in the original image to facilitate subsequent processing of the original image.

Furthermore, the original image may be subjected to binarization or grayscale processing, both of which may reduce the amount of data to be processed in subsequent processing and improve processing speed. Binarization or grayscale processing is used to remove interfering pixels in the original image and retain only the content that needs to be processed, such as characters, graphics, or images. Method of binarization may include threshold method, bimodal method, P parameter method, OTSU method, maximum entropy method, iteration method, and the like. Methods of grayscale processing include component method, maximum method, average method, and weighted average method, and the like.

Then, in step S200, the original image is processed to obtain a preprocessed image, wherein the preprocessed image includes at least one text mask area.

Processing the original image to obtain the preprocessed image includes: annotating a text in the original image based on a pre-trained annotation model to obtain at least one text mask area.

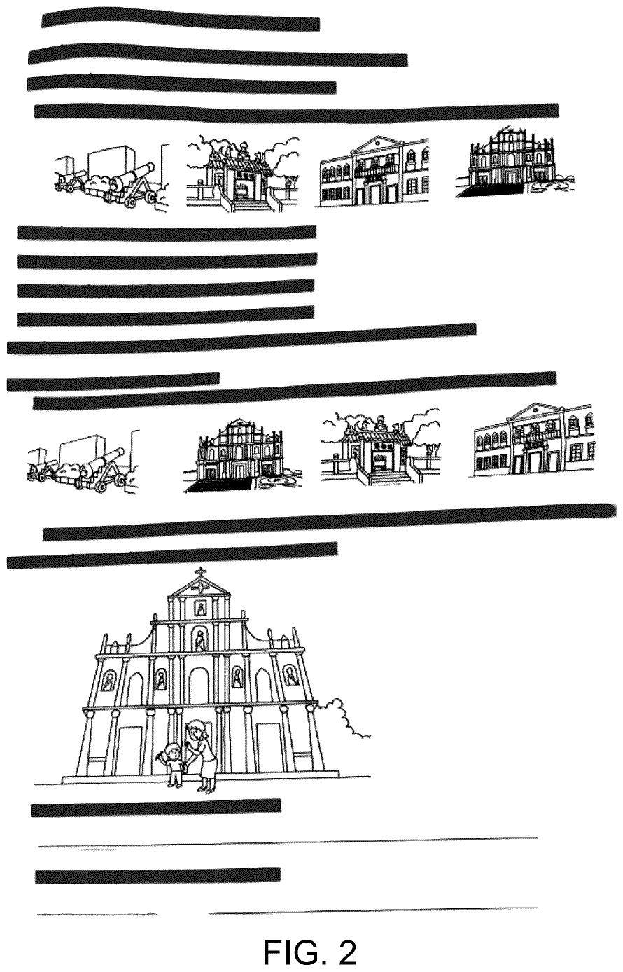

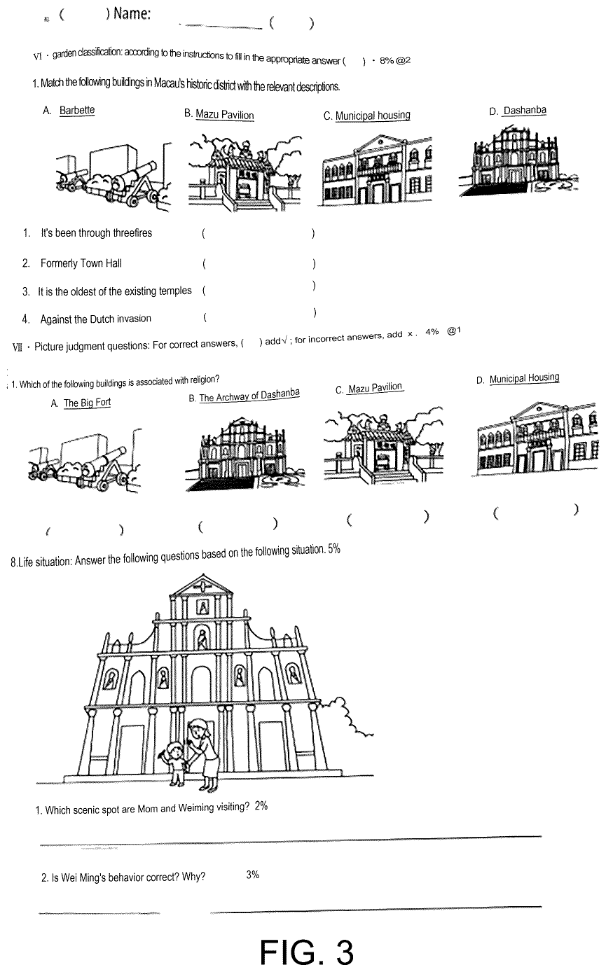

The training process of the annotation model includes:
obtaining a sample image, wherein the sample image includes at least one text line area, and the at least one text line area is arranged along a straight line (when the sample image includes a plurality of text line areas, the plurality of text line areas are arranged in parallel in sequence along the same direction);
performing a mask covering and annotating processing on the at least one text line area and distorting a processed sample image according to a random distortion value to obtain a distorted text mask area, thereby generating a target image. As shown in FIG. 2, a multi-line text mask area is included;
distorting the sample image based on a same distortion value to obtain a distorted text line area, thereby generating a training image. As shown in FIG. 3, the distorted text mask area corresponds to the distorted text line area one by one;
training an annotation model to be trained based on the training image and the target image to obtain a trained annotation model. The annotation model may be implemented using a machine learning technique (e.g., a deep learning technique). For example, in some embodiments, the annotation model may be a neural network-based model. The annotation model may adopt a pix2pixHID (pixel-to-pixel HD) model annotating the preprocessed image using a coarse-to-fine generator and a multi-scale discriminator, etc. to generate an annotated preprocessed image. The generator of the pix2pixHD model includes a global generator network and a local enhancer network. The global generator network adopts a U-Net structure. The features output by the global generator network are fused with the features extracted by the local enhancer network and serve as input information of the local enhancer network. The local enhancer network outputs the preprocessed image after annotation. For example, the annotation model may also use other models, such as a U-Net model, etc., and the disclosure is not limited in this regard.

There is no limit to the method of distortion. In some embodiments, OpenCV may be adopted to implement distortion. For example, first, a set of offsets (distortion values) are randomly generated, and then the offsets are Gaussian filtered to make the offsets smooth and continuous. The offsets after Gaussian filtering are used to generate a distortion parameter matrix (for example, map). Based on the same distortion parameter matrix, the sample image after mask covering and annotating processing and the original sample image are distorted respectively to obtain the target image and the training image respectively.

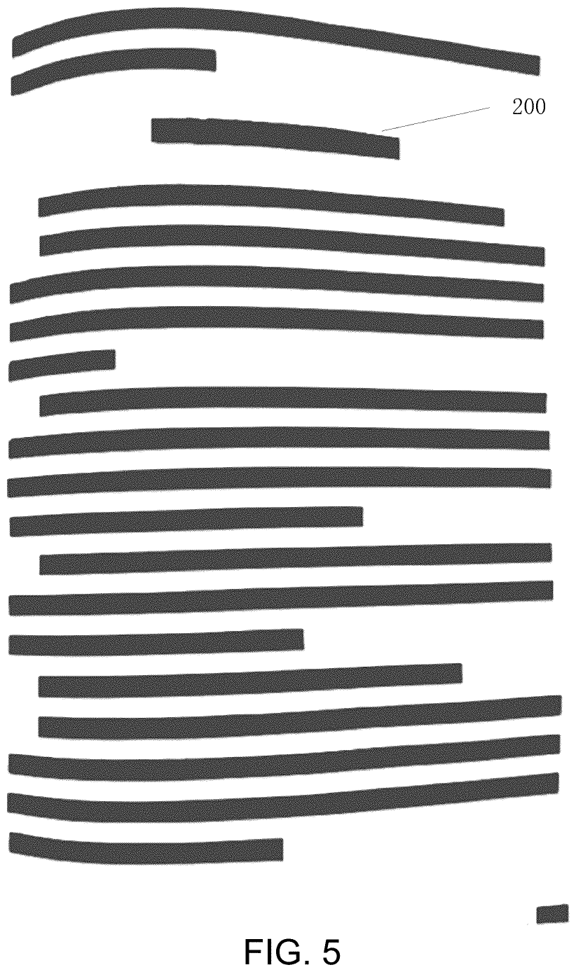

The original image shown in FIG. 4 is annotated based on a pre-trained annotation model to obtain a preprocessed image as shown in FIG. 5, including a plurality of text mask areas, wherein the plurality of text lines in the original image of FIG. 4 and the plurality of text mask areas in the preprocessed image of FIG. 5 correspond one by one, for example, a text line 100 “Dinosaurs are a good entry point for popular science” in FIG. 4 corresponds to a text mask area 200 in FIG. 5.

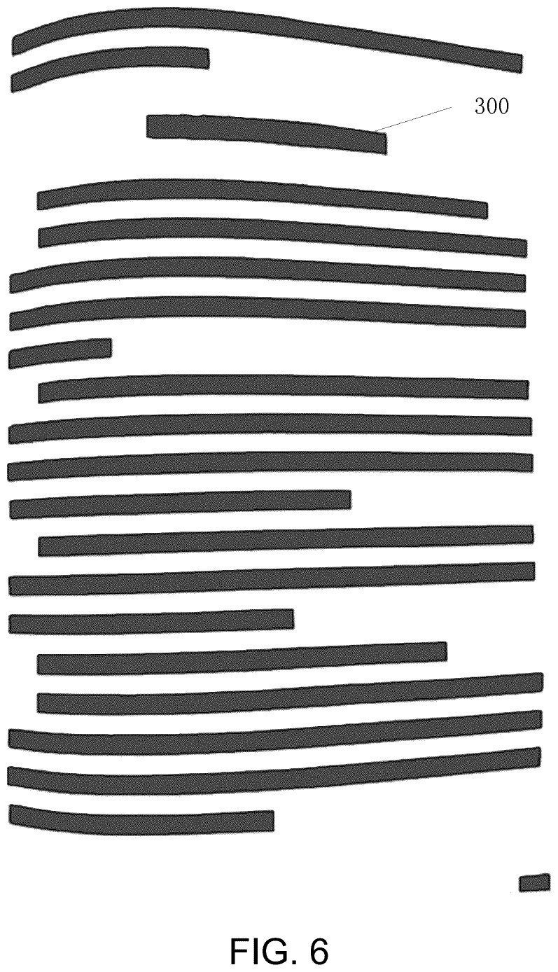

Then in step S300, the outer contour of the at least one text mask area is obtained to obtain at least two contour curves, as shown in FIG. 6. Obtaining the outer contour of the at least one text mask area to obtain the at least two contour curves includes: obtaining the outer contour of the at least one text mask area using an OpenCV algorithm to obtain the at least two contour curves. The outer contour of the at least one text mask area may also be obtained by using other algorithms or by utilizing a pre-trained artificial intelligence-based neural network model for identification and acquisition, and the disclosure in not limited in this regard. As shown in FIG. 6, an outer contour 300 of the at least one text mask area is obtained, including a plurality of contour curves of the upper and lower edges and the left and right edges of the text mask area.

In some embodiments, after obtaining the at least two contour curves, contour curves for which the lengths are less than a set threshold are removed. Thereby, the contour curves of the left and right edges of the outer contour of the text mask area and the contour curves of the upper and lower edges having smaller lengths are removed. For example, the threshold may be set to the width, the height, or the larger value of the width and the height of a single character to remove the contour curves that are too short. The threshold may also be set to a length of, for example, 10 pixel values or set according to actual needs. The disclosure is not limited in this regard. A single character or a shorter text line does not have a great demand for straightening the contour curve. This type of processing may possibly be ignored to only retain the contour curves of the upper and lower edges of the longer text lines.

Then in step S400, the contour curves of the outer contour are fitted to obtain the curve function thereof, and each contour curve in the at least two contour curves is fitted to obtain the curve function thereof respectively. Curve fitting may be performed using various fitting algorithms, and the disclosure is not limited in this regard.

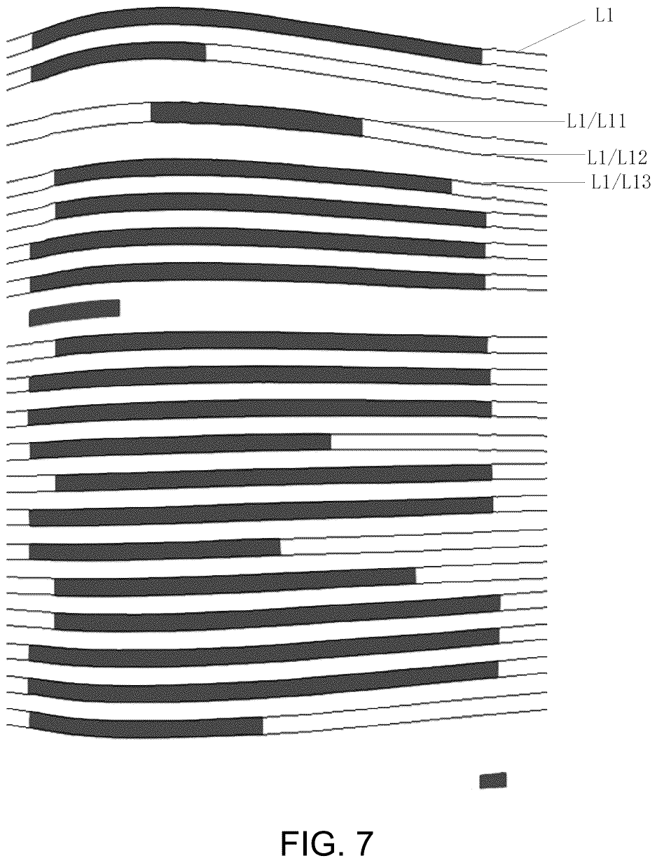

Please refer to FIG. 7. The at least two contour curves may be extended according to the fitted curve function to obtain a plurality of extended contour curves L1, that is, each contour curve in the at least two contour curves is extended respectively to obtain a plurality of contour curves L11, L12, L13, etc. arranged in parallel in the same direction.

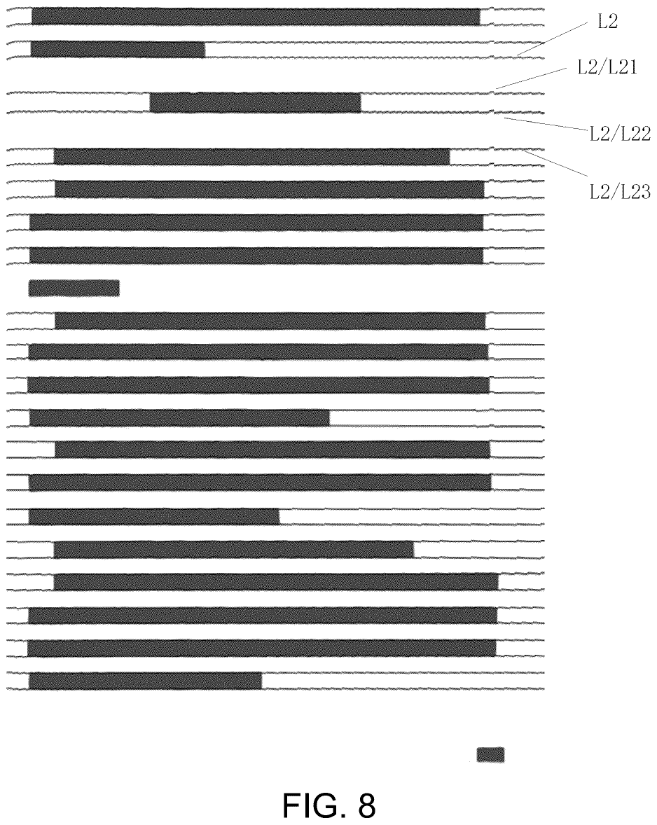

Then in step S500, the contour curves are straightened by the curve function to obtain an intermediate image, wherein the intermediate image includes at least two second lines, the at least two second lines are arranged in parallel in the same direction, and the at least two second lines correspond to the at least two contour curves one by one. Please refer to FIG. 8, the intermediate image includes a plurality of second lines L2 corresponding one by one to the plurality of contour curves L1 in the preprocessed image, that is, the plurality of contour curves such as L11, L12, L13 are respectively straightened according to the curve function to obtain a plurality of corresponding second lines such as L21, L22, L23.

Lastly, step S600 is performed: remapping the original image based on a mapping relationship between the preprocessed image and the intermediate image to obtain an output image.

The mapping relationship between the preprocessed image and the intermediate image includes: a mapping relationship between the at least two contour curves and the at least two second lines, and a mapping relationship between an area between the at least two contour curves in the preprocessed image and an area between the at least two second lines in the intermediate image.

It should be noted that the mapping relationship between the area between the at least two contour curves in the preprocessed image and the area between the at least two second lines in the intermediate image needs to be determined according to the mapping relationship between the at least two contour curves and the at least two second lines.

In some embodiments, remapping the original image based on the mapping relationship between the preprocessed image and the intermediate image to obtain the output image includes:
determining preprocessing mapping information corresponding to the preprocessed image via an interpolation method based on the mapping relationship between the preprocessed image and the intermediate image, wherein the preprocessing mapping information is used to indicate a mapping parameter of at least a portion of pixels in the preprocessed image;
determining mapping information corresponding to an area in the preprocessed image corresponding to the original image based on the preprocessing mapping information;
remapping the original image based on the mapping information corresponding to the original image to obtain the output image.

The preprocessing mapping information is used to indicate mapping parameters of at least a portion of pixels in the preprocessed image. At least a portion of the pixels in the preprocessed image includes pixels in an area between the at least two contour curves in the preprocessed image and pixels on the at least two contour curves. As shown in FIG. 7, the preprocessed image includes the area between the contour curves L11 and L12, that is, the text mask area corresponding to the text line area in the original image. In addition, the preprocessed image also includes the area between the contour curves L12 and L13, that is, the area between adjacent text mask areas corresponding to the area between text lines in the original image. The preprocessing mapping information may indicate mapping parameters of all pixels in the preprocessed image, that is, including mapping parameters of pixels in the above two areas, or may only include mapping parameters of pixels inside the text mask area, and the disclosure is not limited in this regard.

For example, the area between any two adjacent second lines in the intermediate image may correspond to the area between two corresponding adjacent contour curves in the preprocessed image, and each second line in the intermediate image may correspond to a corresponding contour curve in the preprocessed image, so that based on the mapping relationship between the preprocessed image and the intermediate image, the preprocessing mapping information corresponding to the preprocessed image may be determined by an interpolation method. As shown in FIG. 7 and FIG. 8, the area between any two adjacent contour curves L1 in the preprocessed image (for example, the contour curve L11 and the contour curve L12) and the area between two second lines L2 in the intermediate image (for example, the second line L21 and the second line L22) corresponding to the two contour curves L1, respectively, are mapped to each other, that is, the area between the contour curve L11 and the contour curve L12 in the preprocessed image needs to be mapped to the area between the second line L21 and the second line L22 in the intermediate image. The contour curve L1 in the preprocessed image and the second line L2 corresponding to the contour curve L1 in the intermediate image are also mapped to each other. For example, the contour curve L11 and the contour curve L12 in the preprocessed image need to be mapped to the second line L21 and the second line L22 in the intermediate image.

For example, the interpolation method may include nearest neighbor interpolation, bilinear interpolation, bicubic spline interpolation, bicubic interpolation, Lanczos interpolation, etc., and the disclosure does not limit the interpolation method.

For example, the mapping information corresponding to the original image may include mapping parameters corresponding to all pixels in the original image, that is, the number of mapping parameters in the mapping information corresponding to the original image may be the same as the number of all pixels in the original image. For example, the mapping parameter corresponding to a pixel may represent the coordinate value of the position to which the pixel is mapped; or, may represent the offset between the coordinate value of the pixel and the coordinate value of the position to which the pixel is mapped.

It should be noted that the coordinate value of the pixel may be expressed as the coordinate value in the coordinate system corresponding to the original image. The coordinate origin of the coordinate system corresponding to the original image is a pixel point of the original image (for example, the pixel point corresponding to the center of the original image or the pixel point in the upper left corner of the original image), and the two coordinate axes of the coordinate system corresponding to the original image are the width and the height of the original image, respectively. The coordinate value of the position to which the pixel is mapped may be represented by the coordinate value in the coordinate system corresponding to the output image. The coordinate origin of the coordinate system corresponding to the output image is the pixel point in the output image corresponding to the coordinate origin of the coordinate system corresponding to the original image. The two coordinate axes of the coordinate system corresponding to the output image are the width and the height of the output image, respectively.

For example, based on the mapping relationship between the preprocessed image and the intermediate image as a reference benchmark, the mapping parameter corresponding to each pixel in the original image may be determined, so that the mapping information corresponding to the original image may be obtained. The position to which each pixel is mapped after the image distortion is corrected may be determined based on the mapping information corresponding to the original image, thereby realizing the mapping process.

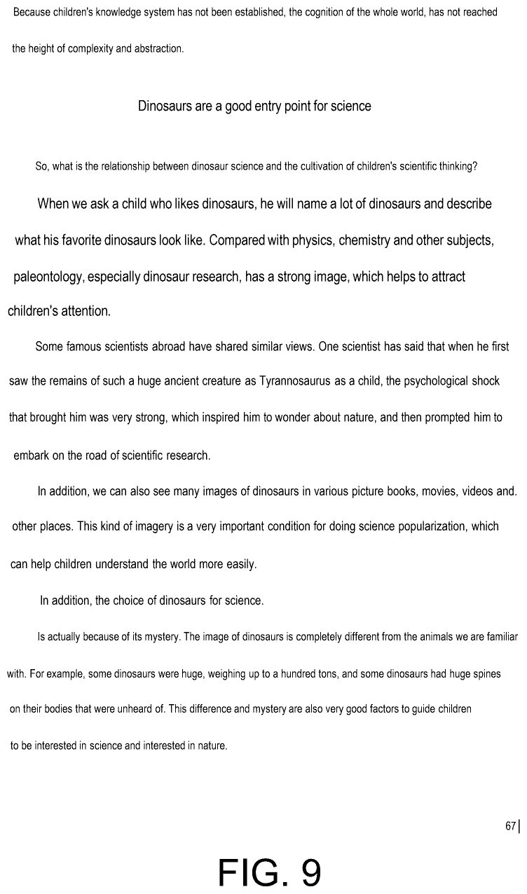

For example, remapping the original image based on mapping information corresponding to the original image to obtain the output image may include: calling a remapping function (i.e., remap function) in OpenCV to remap the original image based on the mapping information corresponding to the original image to obtain the output image. As shown in FIG. 9, in the output image, the lines connecting the centers of the characters in “Dinosaurs are a good entry point for popular science” are located on the same straight line, so that the text is straightened, thereby effectively correcting the distortion of the original image, solving the issue of image distortion, improving the accuracy of the recognition results based on the output image, improving the efficiency of image recognition, enhancing the readability of the image, and improving the experience of the user of viewing the output image.

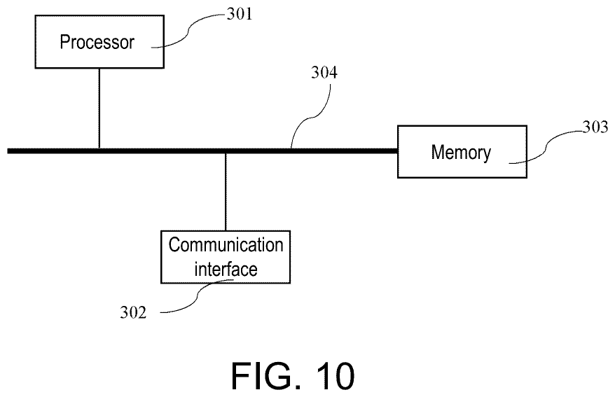

Based on the same inventive concept, the invention also proposes an image processing system containing text, including a processor and a memory, wherein a program is stored in the memory, and when the program is executed by the processor, the image processing method containing text above is implemented. Please refer to FIG. 10. FIG. 10 is a structural diagram of an image processing system containing text provided by an embodiment of the invention. As shown in FIG. 10, the image processing system containing text includes a processor 301, a communication interface 302, a memory 303, and a communication bus 304.

In particular, the processor 301, the communication interface 302, and the memory 303 communicate with each other via the communication bus 304.

The memory 303 is used to store a computer program.

The processor 301 is used to execute the program stored in the memory 303 to implement the following steps:
obtaining an original image;
processing the original image to obtain a preprocessed image, wherein the preprocessed image includes at least one text mask area;
obtaining an outer contour of the at least one text mask area to obtain at least two contour curves;
fitting the contour curves of the outer contour to obtain a curve function thereof;
straightening the contour curves via the curve function to obtain an intermediate image, wherein the intermediate image includes at least two second lines, and the at least two second lines correspond to the at least two contour curves one by one;
remapping the original image based on a mapping relationship between the preprocessed image and the intermediate image to obtain an output image.

For the specific implementation of each step of the method and related explanations, please refer to the method implementation shown in FIG. 1 above, which is not repeated here.

In addition, other implementations of the image processing method containing text implemented by the processor 301 executing the program stored in the memory 303 are the same as the implementations mentioned in the above method implementation portion and are not repeated here.

The communication bus 304 mentioned in the above electronic equipment may be, for example, a Peripheral Component Interconnect (PCI) bus or an Extended Industry Standard Architecture (EISA) bus. The communication bus 304 may be divided into an address bus, a data bus, a control bus, etc. For ease of representation, only one thick line is used in the figure, but this does not mean that there is only one bus or one type of bus.

The communication interface 302 is used for communication between the electronic equipment and other equipment.

The processor 301 may be a central processing unit (CPU), or other general-purpose processors, digital signal processors (DSP), application-specific integrated circuits (ASIC), field-programmable gate arrays (FPGA), or other programmable logic devices, discrete gates, or transistor logic devices, discrete hardware components, etc. The general processor may be a microprocessor or any conventional processor, etc. The processor 301 is the control center of the electronic equipment, and uses various interfaces and circuits to connect various portions of the entire electronic equipment.

The memory 303 may be used to store the computer program. The processor 301 implements various functions of the electronic equipment by running or executing the computer program stored in the memory 303 and calling the data stored in the memory 303.

The memory 303 may include non-volatile and/or volatile memory. The non-volatile memory may include read-only memory (ROM), programmable ROM (PROM), electrically-programmable ROM (EPROM), electrically-erasable programmable ROM (EEPROM), or flash memory. The volatile memory may include random-access memory (RAM) or external cache memory. By way of illustration and not limitation, RAM is available in many forms, such as static RAM (SRAM), dynamic RAM (DRAM), synchronous DRAM (SDRAM), double data rate SDRAM (DDRSDRAM), enhanced SDRAM (ESDRAM), synchronous link (Synchlink) DRAM (SLDRAM), memory bus (Rambus) direct RAM (RDRAM), direct memory bus dynamic RAM (DRDRAM), and memory bus dynamic RAM (RDRAM), etc.

According to another aspect of the disclosure, the invention further provides a storage medium on which a program is stored, and when the program is executed, the following steps are implemented:
obtaining an original image;
processing the original image to obtain a preprocessed image, wherein the preprocessed image includes at least one text mask area;
obtaining an outer contour of the at least one text mask area to obtain at least two contour curves;
fitting the contour curves of the outer contour to obtain a curve function thereof;
straightening the contour curves via the curve function to obtain an intermediate image, wherein the intermediate image includes at least two second lines, and the at least two second lines correspond to the at least two contour curves one by one;
remapping the original image based on a mapping relationship between the preprocessed image and the intermediate image to obtain an output image.

The computer-readable storage medium of an embodiment of the invention may adopt any combination of one or a plurality of computer-readable media. The computer-readable medium may be a computer-readable signal medium or a computer-readable storage medium. The computer-readable storage medium may be, for example but not limited to, an electronic, magnetic, optical, electromagnetic, infrared, or semiconductor system, apparatus, or device, or any combination of the above. More specific examples (a non-exhaustive list) of the computer-readable storage medium include: an electrical connection having one or a plurality of conductors, a portable computer hard disk, a hard disk, a random-access memory (RAM), a read-only memory (ROM), an erasable programmable read-only memory (EPROM or flash memory), optical fiber, a portable compact disk read-only memory (CD-ROM), an optical storage device, a magnetic storage device, or any suitable combination of the above. In this document, the computer-readable storage medium may be any tangible medium that may contain or store a program for use by or in connection with an instruction execution system, apparatus, or device.

The computer-readable signal medium may include a propagated data signal in baseband or as a portion of a carrier wave with a computer-readable program code embodied therein. Such a propagated data signal may take a variety of forms, including but not limited to an electromagnetic signal, an optical signal, or any suitable combination of the above. The computer-readable signal medium may also be any computer-readable medium other than a computer-readable storage medium that may send, propagate, or transport a program for use by or in connection with an instruction execution system, apparatus, or device.

The computer program code for performing an operation of the invention may be written in one or a plurality of programming languages, or a combination thereof, including object-oriented programming languages such as Java, Smalltalk, C++, and conventional procedural programming languages such as “C” or similar programming languages. The program code may be executed entirely on the computer of the user, partly on the computer of the user, as a stand-alone software package, partly on the computer of the user and partly on a remote computer, or entirely on the remote computer or server. In a case involving a remote computer, the remote computer may be connected to the computer of the user via any type of network, including a Local Area Network (LAN) or a Wide Area Network (WAN), or may be connected to an external computer (e.g., via the Internet using an Internet service provider).

It should be noted that the devices and the methods disclosed in the embodiments of this document may also be implemented in other ways. The device implementations described above are merely exemplary. For example, the flowcharts and block diagrams in the accompanying drawings show possible architectures, functions, and operations of devices, methods, and computer program products according to various embodiments of this document. In this regard, each box in the flowchart or block diagram may represent one module, a program, or a portion of code, wherein the module, the program segment, or a portion of code contains one or a plurality of executable instructions for implementing the specified logical functions, and the module, the program segment, or a portion of code contains one or a plurality of executable instructions for implementing the specified logical functions. It should also be noted that, in some alternative implementations, the functions annotated in the block may also occur out of the order annotated in the figures. For example, two consecutive blocks may actually be executed substantially in parallel, or may sometimes be executed in the reverse order, depending on the functions involved. It should also be noted that each box in the block diagram and/or flowchart, and combinations of boxes in the block diagram and/or flowchart, may be implemented by a dedicated hardware-based system for performing the specified functions or actions, or may be implemented by a combination of dedicated hardware and computer instructions.

In addition, the various functional modules in the various embodiments of this document may be integrated together to form an independent portion, or each module may exist independently, or two or more modules may be integrated to form one independent portion.

The above description is only a description of the preferred embodiments of the invention, and does not limit the scope of the invention in any way. Any changes or modifications made by those of ordinary skill in the art based on the above disclosure shall fall within the scope of the claims.

1. An image processing method containing text, that, comprising:
obtaining an original image;
processing the original image to obtain a preprocessed image, wherein the preprocessed image comprises at least one text mask area;
obtaining an outer contour of the at least one text mask area to obtain at least two contour curves;
fitting the contour curves of the outer contour to obtain a curve function thereof;
straightening the contour curves via the curve function to obtain an intermediate image, wherein the intermediate image comprises at least two second lines, and the at least two second lines correspond to the at least two contour curves one by one;
remapping the original image based on a mapping relationship between the preprocessed image and the intermediate image to obtain an output image.

2. The image processing method containing text according to claim 1, wherein the mapping relationship between the preprocessed image and the intermediate image comprises: a mapping relationship between the at least two contour curves and the at least two second lines, and a mapping relationship between an area between the at least two contour curves in the preprocessed image and an area between the at least two second lines in the intermediate image.

3. The image processing method containing text according to claim 1, wherein mapping the original image to obtain the output image based on the mapping relationship between the preprocessed image and the intermediate image comprises:
determining preprocessing mapping information corresponding to the preprocessed image via an interpolation method based on the mapping relationship between the preprocessed image and the intermediate image, wherein the preprocessing mapping information is used to indicate a mapping parameter of at least a portion of pixels in the preprocessed image;
determining mapping information corresponding to an area in the preprocessed image corresponding to the original image based on the preprocessing mapping information;
remapping the original image based on the mapping information corresponding to the original image to obtain the output image.

4. The image processing method containing text according to claim 1, wherein processing the original image to obtain the preprocessed image comprises: annotating a text in the original image based on a pre-trained annotation model to obtain the at least one text mask area.

5. The image processing method containing text according to claim 4, characterized in that, wherein a training process of the annotation model comprises:
obtaining a sample image, wherein the sample image comprises at least one text line area, and the at least one text line area is arranged along a straight line;
performing a mask covering and annotating processing on the at least one text line area and distorting a processed sample image according to a random distortion value to obtain a distorted text mask area, thereby generating a target image;
distorting the sample image based on a same distortion value to obtain a distorted text line area, thereby generating a training image, wherein the distorted text mask area corresponds to the distorted text line area one by one;
training an annotation model to be trained based on the training image and the target image to obtain a trained annotation model.

6. The image processing method containing text according to claim 5, characterized in that, wherein when the sample image comprises a plurality of text line areas, the plurality of text line areas are arranged in parallel in sequence along a same direction.

7. The image processing method containing text according to claim 1, wherein obtaining the outer contour of the at least one text mask area to obtain the at least two contour curves comprises: obtaining the outer contour of the at least one text mask area using an OpenCV algorithm to obtain the at least two contour curves.

8. The image processing method containing text according to claim wherein obtaining the outer contour of the at least one text mask area to obtain the at least two contour curves further comprises: removing contour curves for which lengths are less than a set threshold.

9. The image processing method containing text according to claim 1, wherein after fitting the contour curves of the outer contour and obtaining the curve function thereof, the method further comprises: extending the at least two contour curves according to the curve function.

10. An image processing system containing text, comprising a processor and a memory, wherein a program is stored in the memory, and when the program is executed by the processor, the image processing method containing text according to claim 1 is implemented.

11. A storage medium having a program stored therein, characterized wherein when the program is executed, the image processing method containing text according to claim 1 is implemented.

12. An image processing system containing text, comprising a processor and a memory, wherein a program is stored in the memory, and when the program is executed by the processor, the image processing method containing text according to claim 2 is implemented.

13. An image processing system containing text, comprising a processor and a memory, wherein a program is stored in the memory, and when the program is executed by the processor, the image processing method containing text according to claim 3 is implemented.

14. An image processing system containing text, comprising a processor and a memory, wherein a program is stored in the memory, and when the program is executed by the processor, the image processing method containing text according to claim 4 is implemented.

15. An image processing system containing text, comprising a processor and a memory, wherein a program is stored in the memory, and when the program is executed by the processor, the image processing method containing text according to claim 5 is implemented.

16. An image processing system containing text, comprising a processor and a memory, wherein a program is stored in the memory, and when the program is executed by the processor, the image processing method containing text according to claim 6 is implemented.

17. An image processing system containing text, comprising a processor and a memory, wherein a program is stored in the memory, and when the program is executed by the processor, the image processing method containing text according to claim 7 is implemented.

18. An image processing system containing text, comprising a processor and a memory, wherein a program is stored in the memory, and when the program is executed by the processor, the image processing method containing text according to claim 8 is implemented.

19. An image processing system containing text, comprising a processor and a memory, wherein a program is stored in the memory, and when the program is executed by the processor, the image processing method containing text according to claim 9 is implemented.
